(19) United States
(12) Patent Application Publication
(10) Pub. No.: US 2026/0343601 A1
(43) Pub. Date: Oct. 29, 2026

(54) TRANSPARENT TRANSMIT OPPORTUNITY (TXOP) SHARING BY COLLOCATED STATIONS (STAS) INCLUDING NON-ACCESS POINT (AP) STAS

(71) Applicant: Cisco Technology, Inc., San Jose, CA (US)

(72) Inventors: Brian D. Hart, Sunnyvale, CA (US); Binita Gupta, San Diego, CA (US); Malcolm Muir Smith, Richardson, TX (US)

(21) Appl. No.: 19/660,858

(22) Filed: Apr. 28, 2026

Related U.S. Application Data
(60) Provisional application No. 63/795,989, filed on Apr. 28, 2025.

(51) Int. Cl. H04W 74/0808; H04W 28/082

(52) U.S. Cl. CPC H04W 74/0808; H04W 28/082

(57) ABSTRACT

Transparent Transmit Opportunity (TXOP) sharing by collocated Stations (STAs) including non-Access Point (AP) STAs may be provided. An Access Point (AP) may send a TXOP sharing policy for collocated stations. Next, the AP may determine, for a client device, a conformity status with the TXOP sharing policy for collocated stations.

### RELATED APPLICATION

Under provisions of 35 U.S.C. § 119(e), Applicant claims the benefit of U.S. Provisional Application No. 63/795,989, filed Apr. 28, 2025, which is incorporated herein by reference.

### TECHNICAL FIELD

The present disclosure relates generally to providing Transparent Transmit Opportunity (TXOP) sharing by collocated Stations (STAs) including non-Access Point (AP) STAs.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing Transparent Transmit Opportunity (TXOP) sharing by collocated Stations (STAs) including non-Access Point (AP) STAs;

FIG. 2 is a flow chart of a method for providing TXOP sharing by collocated STAs including non-AP STAs; and

FIG. 3 is a block diagram of a computing device.

### DETAILED DESCRIPTION

### Overview

Transparent Transmit Opportunity (TXOP) sharing by collocated Stations (STAs) including non-Access Point (AP) STAs may be provided. An Access Point (AP) may send a TXOP sharing policy for collocated stations. Next, the AP may determine, for a client device, a conformity status with the TXOP sharing policy for collocated stations.

Both the foregoing overview and the following example embodiments are examples and explanatory only and should not be considered to restrict the disclosure’s scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Coordinated Time Division Multiple Access (Co-TDMA) in the Institute of Electrical and Electronics Engineers (IEEE) 802.11bn amendment to the 802.11 standard may allow non-collocated APs to share portions of a Transmit Opportunity (TXOP). It may be desired to have collocated APs, indicated by Multiple Basic Service Set Identifier (MBSSID)/Co-hosted AP signaling (or new signaling), to be able to do the same thing, with the optimization that control frames between collocated APs may not need to be sent over the air. In response, it may be desired to have non-AP STAs be granted the same privilege. However there may be some differences. First, client devices currently may not advertise their other collocated Wi-Fi devices (e.g., Peer-to-Peer (P2P) interfaces). Furthermore, client devices may be a mix of AP and non-AP STAs.

For the collocated STAs (e.g., with different Media Access Control (MAC) addresses) in a client device (e.g., a laptop, a smartphone, etc.) to share portions of a TXOP among themselves with a Short Interframe Space (SIFS) between the portions, embodiments of the disclosure may provide that a range or a list of collocated MAC address using this facility be disclosed by the client device to the AP. This may discourage abuse of this TXOP sharing privilege by the client device and may enable policing by the AP or other devices.

Embodiments of the disclosure may also trigger fairness rules for TXOP sharing that currently apply to APs, but would be extend to these use cases too. Furthermore, embodiments of the disclosure may ensure that the client device does not grant portions of its TXOP to other non-collocated devices such as P2P or Wi-Fi Direct or Neighborhood Aware Networking (NAN) devices. This may be especially true if the client device was granted, by its AP, a portion of the TXOP via the TXOP sharing (TXS) procedure, and then the client device tries to grant a sub-portion of that portion to another non-collocated client device whose characteristics such as value/business criticality/security posture is completely unknown to the AP that granted the portion to the client device.

For client devices that choose not to provide collocated MAC addresses or abide by the fairness rules, the AP may disincentive such TXOP sharing by disassociating the client device or load balancing (aka band-steering) it to a congested channel. To help client devices understand that they may be risking such disincentives beforehand, the AP may advertise this policy up front to the client devices. Accordingly, given collocated non-AP STAs are interested in sharing a TXOP among themselves, embodiments of the disclosure may define rules and related signaling to enable verification that this facility is not being abused (e.g., by granting a portion of the TXOP to non-collocated STAs) and so that fairness rules may be invoked.

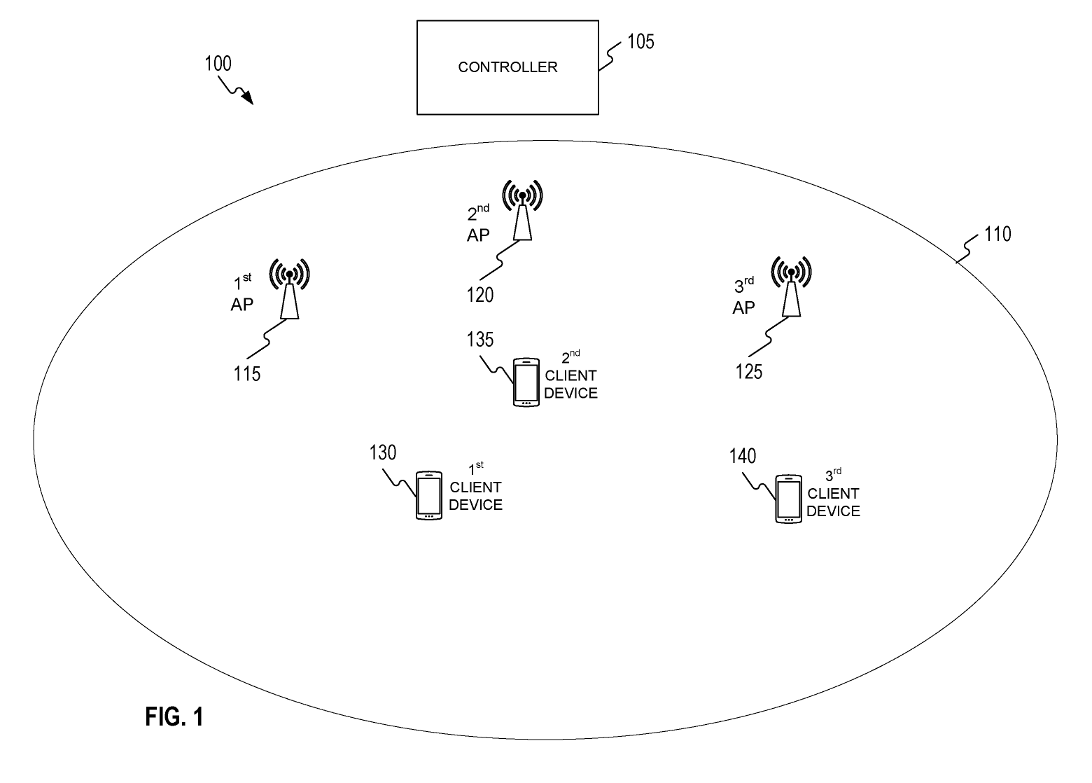

FIG. 1 shows an operating environment 100 for providing Transparent Transmit Opportunity (TXOP) sharing by collocated Stations (STAs) including non-Access Point (AP) STAs. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the LAN and/or Internet for wireless client devices). The plurality of APs may comprise a first AP 115, a second AP 120, a third AP 125. As described below, the plurality of APs may comprise any number of APs and is not limited to three. The plurality of AP devices may comprise AP Multi-Link Devices (MLDs).

The plurality of APs may provide wireless network access to a plurality of client devices (i.e., Station (STAs)) as they move within coverage environment 110. The plurality of client devices may comprise, but are not limited to, a first client device 130, a second client device 135, and a third client device 140. The plurality of client devices may comprise non-AP Multi-Link Devices. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, an Automated Transfer Vehicle (ATV), a drone, a vehicle, an autonomous vehicle, an Unmanned Aerial Vehicle (UAV), Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard.

The plurality of APs and the plurality of client devices may use Multi-Link Operation (MLO) where they simultaneously transmit and receive across different bands (or links) and channels by establishing two or more links to two or more AP radios. Accordingly, the plurality of APs and the plurality of client devices may comprise Multi-Link Devices (MLDs). These bands may comprise, but are not limited to the 2.4 GHz band, the 5 GHz band, the 6 GHz band, and the 60 GHz band. The two or more links on any given one of the plurality of client devices may be made with any one AP or with any combination of the APs.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide TXOP sharing by collocated STAs including non-AP STAs. In some embodiments, the controller functionality might be collocated with an AP, distributed across multiple APs, be performed in the cloud, or be distributed across the cloud and a local networked appliance.

Consistent with embodiments of the disclosure, first AP 115 may be tagged with a set of BSSIDs (e.g., “AP/employee; AP/guest”), and may be connected to two client devices, for example, first client device 130 and second client device 135. First client device 130 may be tagged with “client/employee” and second client device 135 may be tagged with “client/guest” with arrows between first AP 115 and each of first client device 130 and second client device 135. Also third client device 140 may be connected to third AP 125 “client/employee” and “AP/employee”. To illustrate P2P, first client device 130 may be connected to third client device 140 with an arrow, so third client device 140 tagging extends to “client/employee, AP/gaming” and first client device 130 tagging extends to “client/employee, client/gaming”. In this way, first client device 130 may comprise a multi-BSS client and third client device 140 may be both a client and an AP.

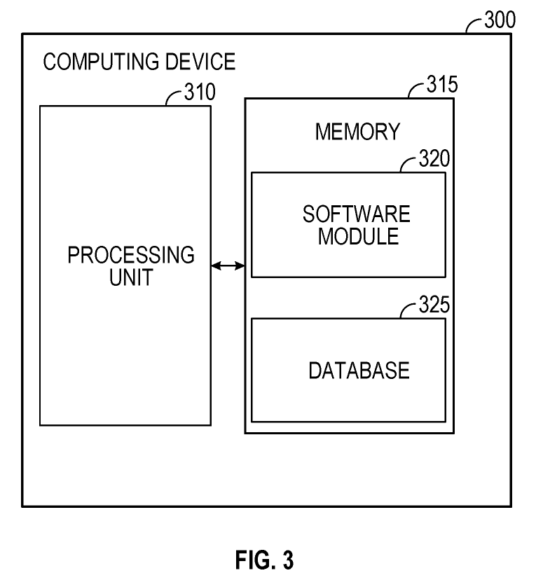

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

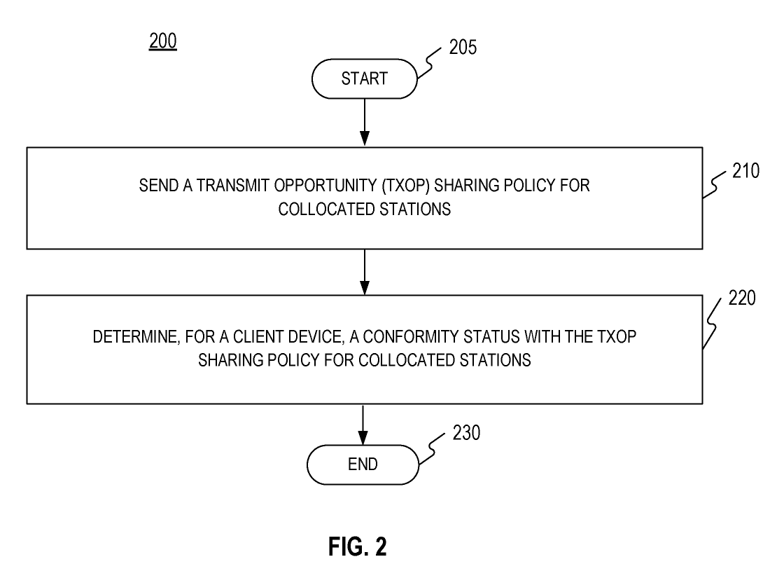

FIG. 2 is a flow chart setting forth the general stages involved in a method 200 consistent with embodiments of the disclosure for providing TXOP sharing by collocated STAs including non-AP STAs. Method 200 may be implemented using first AP 115 that may be embodied by computing device 300 as described in more detail below with respect to FIG. 3. Ways to implement the stages of method 200 will be described in greater detail below.

Method 200 may begin at starting block 205 and proceed to stage 210 where first AP 115 may send a Transmit Opportunity (TXOP) sharing policy for collocated stations. For example, first AP 115 may advertise its TXOP sharing policy for collocated stations as a field or set of fields in an Ultra High Reliability (UHR) Operation element (or a new UHR element that carries UHR operating mode parameters such as a UHR Operating Parameters element). This element may be included at least one of a beacon or a probe/(re)association response frame. Values of the field(s) in this element may indicate various aspects of the TXOP sharing policy for collocated stations. For example, values of a field may indicate two or more of: that TXOP sharing is not allowed, that TXOP sharing is allowed without restriction, or that TXOP sharing is allowed subject to client device 130 disclosing to first AP 115 all the MAC addresses of collocated STAs to which client device 130 intends to share TXOP with.

Furthermore, values of field(s) in the aforementioned element may indicate that TXOP sharing is allowed based on fairness rules. One of these fairness rules, for example, may provide that only a certain portion or percentage of TXOPs obtained from first AP 115 may be shared with other interfaces (i.e., STAs) on first client device 130 as signaled by the policy. Another fairness rule may provide that TXOPs may only be shared by other interfaces on first client device 130 to exchange traffic of a same (or higher) Access Category (AC) for which the TXOP was obtained. Yet another fairness rule may provide that TXOPs may only be shared to serve traffic of a predetermined Quality-of- Service (QoS) Traffic Identifier (TID). In other words, TXOPs may only be shared to serve traffic of high QoS TIDs as indicated by first AP 115 (e.g., Voice (VO) TIDs (6 and 7) and/or Video (VI) TIDs (4 and 5). Conversely first AP 115 may indicate that TXOPs are not allowed to be shared for low QoS TIDs (e.g., Background (BK) or Best Effort (BE) traffic).

From stage 210, where first AP 115 sends the TXOP sharing policy for collocated stations, method 200 may advance to stage 220 where first AP 115 may determine, for first client device 130, a conformity status with the TXOP sharing policy for collocated stations. For example, if first AP 115 (or another device), policing the TXOP sharing policy, determines that first client device 130 is not conforming to the TXOP sharing policy, first AP 115 may transmit a field to first client device 130 indicating the issue, before or alongside disincentivizing first client device 130. This may be accomplished by sending a defined Reason Code or a Vendor Specific (VS) reason code in any hierarchy of frame, element, subelement, field or subfield, in any order with omission or duplication allowed (e.g., a field in a field in an element in a frame). Important examples include: in the field in a VS element in a disassociation frame, or similar in a Basic Service Set (BSS) Transition Management (BTM) Request frame or a VS action frame or similar. Disincentivizing first client device 130 may comprise, but is not limited to, disassociating first client device 130 or load balancing (bandsteering) first client device 130 to a congested channel.

A nearby device may detect infringement of the TXOP sharing policy by observing the following. First, a device may detect TXOP sharing policy infringement by noticing two different MAC addresses as a Transmitter Address (TA) in non-response frames in PPDUs sent in the same TXOP (with PPDUs at SIFS spacing) without intervening Co-TDMA or related control frame exchanges and where one of the addresses is known to belong to an associated non-AP STA. Furthermore, if the non-AP STA discloses its addresses, a device may detect TXOP sharing policy infringement by also noticing a first of those addresses in the MAC header of the frame and, in later frame in the same TXOP, another of those addresses in the MAC header. As well, since a client might not disclose all its addresses, infringement may further require analyzing frames within a TXOP that include, identifying frames sent by the TXOP holder and response frames, and identify if there are any anomalies such as transmissions orchestrated by other than the TXOP-holder and not subject to protocol allowances such as Reverse Direction Grant or TXOP Sharing (TXS), wherein the MAC address of the TXOP holder or the other orchestrator is known to belong to an associated non-AP STA.

A device (e.g., client form factor device) with one or more APs (in the general sense) (e.g., Wi-Fi Direct Group Owner) and one or more non-AP STAstransmit the MaxBSSID Indicator field in the MBSSID element or Max Co-Hosted BSSID Indicator field in the High Efficiency (HE) Operation element or some new but similar field (e.g., in the UHR Operation element) or some alternatively formatted field (such as an indication of a range of contiguous MAC addresses, a list of non-contiguous MAC addresses, or a list of duples where each duple comprises a base MAC address and a range indication around the base MAC address, where the range indication might follow the MaxBSSID Indicator field and this may indicate both its AP and non-AP STAs. More generally, the field to indicate a set of the collocated cochannel MAC addresses may be included in any hierarchy of frame, element, subelement, field or subfield, in any order with omission or duplication allowed (e.g., a field in a field in an element in a frame). A device (e.g., client form factor device) with one or more non-AP-STAs (in the general sense) (e.g., Wi-Fi Direct/NAN client) transmits a list or range or a list of ranges for its set of MAC addresses for other interfaces (similar to described above, such as the MaxBSSID Indicator or Max Co-Hosted BSSID Indicator fields). These may be sent in the clear or only in encrypted frames (e.g., in an association request given IEEE 802.11bi privacy, or in a Protected Management frame (PMF) sent after association, including in a Wi-Fi Alliance (WFA)-defined vendor specific action frame intended to privately transfer capabilities. In general the field(s) (such as an indication of a range of contiguous MAC addresses, a list of non-contiguous MAC addresses, or a list of duples where each duple comprises a base MAC address and a range indication around the base MAC address may be included in any hierarchy of frame, element, subelement, field or subfield, in any order with omission or duplication allowed (e.g., a field in a field in an element in a frame). A device may indicate if the co-located MAC addresses are under a Randomized and Changing MAC (RCM) scheme such as IEEE 802.11bi, and if so, the relevant RCM parameters such as the epoch (if the STA is associated with this AP) or similar RCM parameters if not. Once first AP 115 determines, for first client device 130, the conformity status with the TXOP sharing policy for collocated stations in stage 220, method 200 may then end at stage 230.

Method 200 may cover embodiments of the disclosure from the perspective of an AP, however embodiments of the disclosure cover the client side perspective also. For example, a client device may report that it has multiple (collocated cochannel) STAs (APs and/or non-AP STAs such as by identifying two or more of its collocated cochannel MAC addresses. Next one STA contends for a TXOP, wins, and transmits to peer(s) for a portion of the TXOP. Then SIFS later, another collocated STA for another portion of the TXOP, if capable and while more collocated STAs can use another portion of the TXOP and applicable fairness requirements are not violated, loop back or otherwise jump ahead to end.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing TXOP sharing by collocated STAs including non-AP STAs as described above with respect to FIG. 2. Computing device 300, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
sending, by an Access Point (AP), a Transmit Opportunity (TXOP) sharing policy for collocated stations; and
determining, for a client device, a conformity status with the TXOP sharing policy for collocated stations.

2. The method of claim 1, wherein determining the conformity status comprises determining that the client device does not conform to the TXOP sharing policy for collocated stations.

3. The method of claim 2, further comprising notifying the client device that the client device does not conform to the TXOP sharing policy for collocated stations in response to determining that the client device does not conform to the TXOP sharing policy for collocated stations.

4. The method of claim 2, further comprising disincentivizing the client device in response to determining that the client device does not conform to the TXOP sharing policy for collocated stations.

5. The method of claim 4, wherein disincentivizing the client device comprises disassociating the client device from the AP.

6. The method of claim 4, wherein disincentivizing the client device comprises load balancing the client device to a congested channel.

7. The method of claim 1, wherein the TXOP sharing policy for collocated stations does not allow TXOP sharing.

8. The method of claim 1, wherein the TXOP sharing policy for collocated stations allows TXOP sharing without restriction.

9. The method of claim 1, wherein the TXOP sharing policy for collocated stations allows TXOP sharing subject to the client device providing the Media Access Control (MAC) addresses to the AP that the client device will share TXOPs.

10. The method of claim 1, wherein the TXOP sharing policy for collocated stations allows TXOP sharing based on at least one fairness rule.

11. The method of claim 10, wherein the at least one fairness rule allows only a maximum of a predetermined proportion of a TXOP obtained by the client device to be shared.

12. The method of claim 10, wherein the at least one fairness rule allows a TXOP to only be shared to serve a same or higher-priority Access Category (AC) traffic for which the client device obtained the TXOP for.

13. The method of claim 10, wherein the at least one fairness rule allows TXOPs to only be shared to serve traffic of a predetermined set of Quality-of- Service (QoS) ACs or Traffic Identifiers (TIDs).

14. The method of claim 1, wherein sending the TXOP sharing policy for collocated stations comprises sending the TXOP sharing policy for collocated stations in an Ultra High Reliability (UHR) Operation element.

15. A system comprising:
a memory storage; and
a processing unit disposed in an Access Point (AP) and coupled to the memory storage, wherein the processing unit is operative to:
send a Transmit Opportunity (TXOP) sharing policy for collocated stations; and
determine, for a client device, a conformity status with the TXOP sharing policy for collocated stations.

16. The system of claim 15, wherein the TXOP sharing policy for collocated stations allows TXOP sharing subject to the client device providing the Media Access Control (MAC) addresses to the AP that the client device will share TXOPs.

17. The system of claim 15, wherein the TXOP sharing policy for collocated stations allows TXOP sharing based on at least one fairness rule.

18. A non-transitory computer-readable medium that stores a set of instructions which when executed perform a method executed by the set of instructions comprising:
sending, by an Access Point (AP), a Transmit Opportunity (TXOP) sharing policy for collocated stations; and
determining, for a client device, a conformity status with the TXOP sharing policy for collocated stations.

19. The non-transitory computer-readable medium of claim 18, wherein determining the conformity status comprises determining that the client device does not conform to the TXOP sharing policy for collocated stations.

20. The non-transitory computer-readable medium of claim 19, further comprising disincentivizing the client device in response to determining that the client device does not conform to the TXOP sharing policy for collocated stations.
